(19) United States
(12) Patent Application Publication
(10) Pub. No.: US 2009/0147209 A1
(43) Pub. Date: Jun. 11, 2009

(54) DISPLAY SUBSTRATE AND DISPLAY DEVICE

(76) Inventors: Min-Goo Seok, Yongin-si (KR); Hyun-Wuk Kim, Asan-si (KR); Yong-Kuk Yun, Hwasung-si (KR)

Correspondence Address: Haynes and Boone, LLP;IP Section, 2323 Victory Avenue, SUITE 700, Dallas, TX, 75219, US

(21) Appl. No.: 12/272,690

(22) Filed: Nov. 17, 2008

(30) Foreign Application Priority Data
Dec. 10, 2007 (KR) 10-2007-0127507

(51) Int. Cl. G02F 1/1333; C09K 19/00; B32B 7/02

(52) U.S. Cl. 349/161; 428/1.3; 428/1.32; 428/212

(57) ABSTRACT

One or more embodiments of the present disclosure provide a color filter substrate and an LCD that discharge heat introduced to LCs to the outside to prevent phase transition of the LCs. In an embodiment, the LCD includes a substrate, a light blocking member disposed on the substrate to define a plurality of open regions, and a heat transfer layer disposed on the light blocking layer. The LCD prevents heat from flowing to the LCs and discharges the heat to the outside to prevent phase transition of the LCs.

### CROSS-REFERENCE TO RELATED APPLICATION

This application claims priority to and benefit from Korean Patent Application No. 10-2007-0127507 filed on Dec. 10, 2007, the contents of which are incorporated by reference in their entirety.

### BACKGROUND

Embodiments according to the present disclosure generally relate to a display substrate and a display device, and more particularly, to a display substrate and a display device that may discharge heat introduced into the device to the outside in order to prevent phase transition of liquid crystals.

Generally, a liquid crystal display apparatus (LCD) is a display device displaying an image using liquid crystals having optical and electrical characteristics of anisotropy in a refractive index, and anisotropy in a dielectric constant. The LCD is slim and lightweight and has a low driving voltage and low power consumption compared to other display devices such as cathode ray tubes (CRTs) and plasma display panels (PDP), so that the LCD is widely used in the industry.

The LCD includes a liquid crystal (LC) display panel including a thin film transistor (TFT) substrate, a color filter substrate facing the TFT substrate, and an LC layer interposed between the two substrates to change light transmittance. Also, since the LCD is not a self-luminous device in which an LC display panel displaying an image can emit light spontaneously, it requires a backlight assembly supplying light onto the LC display panel.

While the LCD may be used, particularly, in a large-sized display device such as a digital information display (DID), in an outside environment, heat is generated due to sunlight in the outside or a driving operation inside the device. The generated heat may be transferred to respective portions of the LCD through a general heat transfer method, that is, radiation, conduction, and convection. Heat transferred to the LC display panel, particularly, to the LC layer is under consideration. That is, the LC layer formed of an organic material has a phase transition temperature of the organic material itself. The organic material changes its phase at this phase transition temperature. When more than a predetermined amount of heat is transferred to the LC layer, phase transition of the LCs is generated. The phase transition of the LCs causes a change in an LC arrangement. When the LC arrangement changes, undesired color, for example, black color, may be visible.

### SUMMARY

Embodiments according to the present disclosure provide a display substrate and a display device that prevent heat from flowing into the inside of the device, particularly LCs, and discharge heat to the outside.

In accordance with an exemplary embodiment, a display substrate includes: a substrate; a light blocking member disposed on the substrate; and a heat transfer part contacting the light blocking member.

The heat transfer part may be formed on an upper surface or a lower surface of the light blocking member.

The heat transfer part may be formed between the light blocking member and the substrate, or formed on one side of the light blocking member having one side contacting the substrate. The heat transfer part may include at least one of silicon carbide (SiC), aluminum nitride (AlN), or titanium carbide (TiC), or a combination selected from SiC, AlN, or TiC. The heat transfer part may be formed in the same pattern as that of the light blocking member, or a pattern that may be concealed by the pattern of the light blocking member.

The heat transfer part may have a size equal to or smaller than that of the light blocking member.

In accordance with another exemplary embodiment, a display device includes: a first substrate; a light blocking member disposed on the first substrate; a color filter disposed on the light blocking member, a common electrode disposed on the color filter; a second substrate facing the first substrate; a thin film transistor disposed on the second substrate; a passivation layer on the thin film transistor; a pixel electrode on the passivation layer; and a heat transfer part disposed on the first substrate or the second substrate.

The heat transfer part may have a size corresponding to that of the light blocking member. The heat transfer part may be formed on at least one of at least one side of the first substrate, at least one side of the light blocking member, and at least one side of the common electrode. The heat transfer part may be formed on at least one of at least one side of the second substrate, at least one side of the thin film transistor, at least one side of the passivation layer, and at least one side of the pixel electrode.

In accordance with yet another exemplary embodiment, a display device includes: a first substrate including a color filter, a light blocking member, and a common electrode; a second substrate including a thin film transistor, a passivation layer, and a pixel electrode; and a heat transfer part on one of the first substrate and the second substrate.

The heat transfer part may be formed on at least one of one side of the first substrate not facing the second substrate, between the substrate and the color filter or the light blocking member, and between the color filter or the light blocking member and the common electrode. The heat transfer part may be formed on at least one of one side of the second substrate not facing the first substrate, between the substrate and the thin film transistor, between the thin film transistor and the passivation layer, and between the passivation layer and the pixel electrode.

The heat transfer part may include at least one of silicon carbide (SiC), aluminum nitride (AlN), or titanium carbide (TiC), or a combination selected from SiC, AlN, or TiC. The heat transfer part may be formed in the same pattern as that of the light blocking member, or a pattern that may be concealed by the pattern of the light blocking member.

A printed circuit film may be provided on at least one of the first substrate and the second substrate, and a heat transfer line may be provided, the heat transfer line having one end connected to the heat transfer part and having the other end connected to an exposure portion exposed to an outside environment through the printed circuit film or escaping the printed circuit film. The exposure portion may be surrounded by a protector.

In accordance with still another exemplary embodiment, a display device includes: a first substrate including at least one of a light blocking member, a color filter, an overcoat layer, an alignment layer, and a common electrode; and a second substrate attached to the first substrate, and including at least one of a thin film transistor, a passivation layer, and a pixel electrode. A heat transfer part including a heat transfer portion may be disposed on the first substrate or the second substrate.

The heat transfer portion may include at least one of silicon carbide (SiC), aluminum nitride (AlN), or titanium carbide (TiC), or a combination selected from SiC, AlN, or TiC. 1 ppm or more of the heat transfer portion may be contained.

A printed circuit film may be provided on at least one of the first substrate and the second substrate, and a heat transfer line may be provided, the heat transfer line having one end connected to the heat transfer part through the printed circuit film or escaping the printed circuit film, and having the other end connected to an exposure portion exposed to an outside environment. The exposure portion may be surrounded by a protector.

The display device may include an LC layer.

### BRIEF DESCRIPTION OF THE DRAWINGS

Exemplary embodiments can be understood in more detail from the following description taken in conjunction with the accompanying drawings, in which:

FIG. 1 is a conceptual plan view of an LCD according to an embodiment of the present disclosure;

FIG. 2 is a conceptual cross-sectional view taken along a line A-A of FIG. 1;

FIG. 3 is a conceptual cross-sectional view taken along a line B-B of FIG. 1;

FIGS. 4 and 5 are views illustrating a modification of FIG. 2 according to one or more embodiments of the present disclosure;

FIG. 6 is a view of an LCD according to another embodiment of the present disclosure;

FIG. 7 is a view of an LCD according to still another embodiment of the present disclosure;

FIG. 8 is a schematic of an exploded perspective view of an LCD according to an embodiment of the present disclosure;

FIGS. 9A through 9C are plan views illustrating a portion of an LCD according to an embodiment of the present disclosure; and

FIG. 10 is a perspective view of an LCD according to an embodiment of the present disclosure.

### DETAILED DESCRIPTION OF EMBODIMENTS

Advantages and features of embodiments of the present invention and methods of accomplishing the same may be understood more readily by reference to the following detailed description of embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and will only be defined by the appended claims. Like reference numerals refer to like elements throughout the specification.

It will be understood that when an element or layer is referred to as being “on”, “connected to” or “coupled to” another element or layer, it can be directly on, connected or coupled to the other element or layer, or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

Embodiments described herein will be described referring to plan views and/or cross-sectional views by way of ideal schematic views of the embodiments. Accordingly, the exemplary views may be modified depending on manufacturing technologies and/or tolerances. Therefore, the embodiments of the invention are not limited to those shown in the views, but include modifications in configuration formed on the basis of manufacturing processes. Therefore, regions exemplified in figures have schematic properties, and shapes of regions shown in figures exemplify specific shapes of regions of elements and do not limit aspects according to the embodiments of the invention.

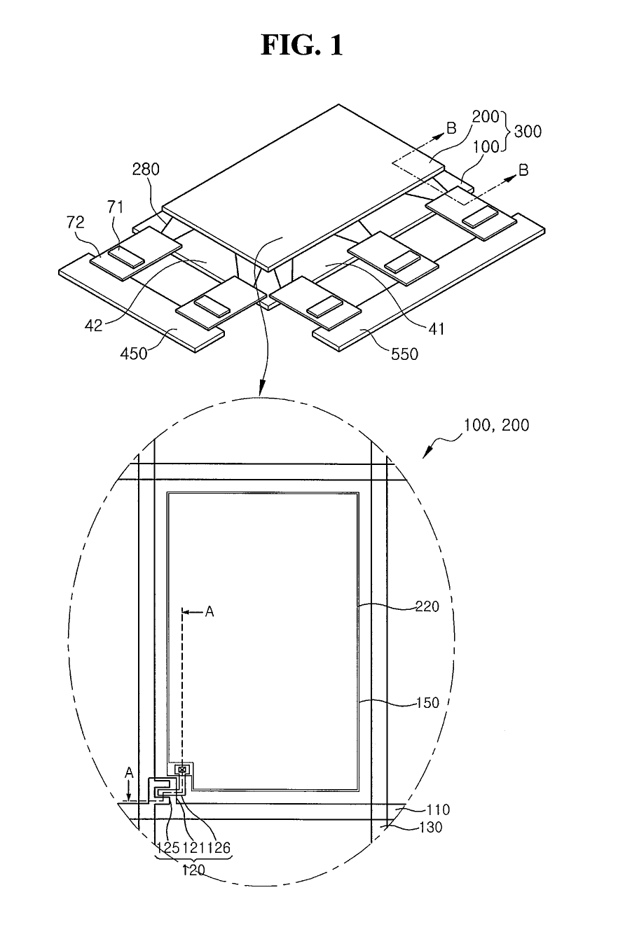

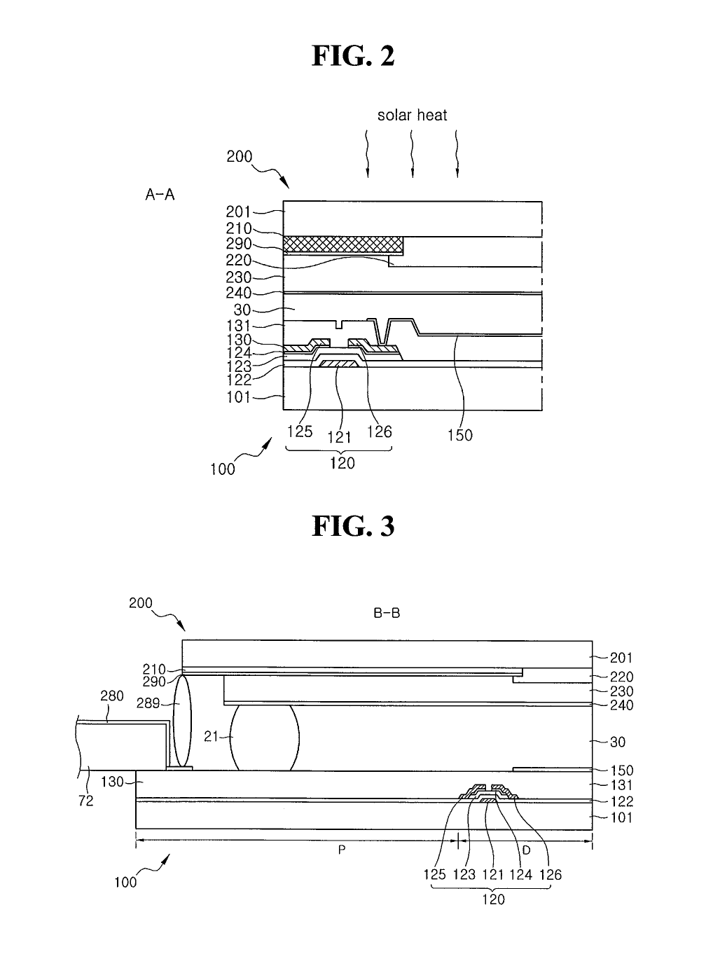

FIG. 1 is a conceptual plan view of an LCD according to an embodiment of the present disclosure, FIG. 2 is a conceptual cross-sectional view taken along a line A-A of FIG. 1, and FIG. 3 is a conceptual cross-sectional view taken along a line B-B of FIG. 1.

Referring to FIGS. 1 through 3, the LCD includes an LC panel 300, a plurality of flexible printed circuit films 72 attached on the LC panel 300, a driving circuit chip 71 on the flexible printed circuit films 72, and printed circuit boards (PCBs) 450 and 550 attached on the flexible printed circuit film 72. The LC panel 300 includes a thin film transistor (TFT) substrate 100, which is a lower substrate, a color filter substrate 200, which is an upper substrate facing the lower substrate, and an LC layer (not shown) interposed between the two substrates and aligned in a desired direction with respect to the two substrates.

The TFT substrate 100 includes a plurality of gate lines 110 on a light transmissive insulating substrate 101, horizontally extending and vertically arranged with a predetermined interval, each gate line delivering a gate signal. TFT substrate 100 also includes a plurality of data lines 130 crossing the gate lines 110, a pixel electrode 150 formed in each pixel region defined by the gate lines 110 and the data lines 130, and a plurality of TFTs 120 connected to the pixel electrode 150 and formed in a matrix configuration at crossings between the gate lines 110 and the data lines 130.

The TFT 120 allows a pixel signal supplied to the data line 130 to charge the pixel electrode 150 in response to a signal supplied to the gate line 110. The TFT 120 includes a gate electrode 121 connected to the gate line 110, a source electrode 125 connected to the data line 130, a drain electrode 126 connected to the pixel electrode 150, a gate insulating layer 122 and an active layer 123 sequentially formed between the gate electrode 121, the source electrode 125, and the drain electrode 126, and an ohmic contact layer 124 formed on at least a portion of the active layer 123. At this point, the ohmic contact layer 124 may be formed on a portion of the active layer 123 excluding a channel portion.

Also, an insulating passivation layer 131 is formed on the TFT 120. The passivation layer 131 may be formed of an inorganic material such as a silicon nitride or a silicon oxide, or it may be formed of an organic layer of a low dielectric constant. The passivation layer 131 may also be formed of a double layer of an inorganic layer and an organic layer.

Also, the pixel electrode 150 may be formed of indium-tin-oxide (ITO) or indium-zinc-oxide (IZO), which is a transparent conductive material, and is formed in the pixel region on the passivation layer 131.

Meanwhile, a light blocking member, i.e., a black matrix (BM) 210, red, green, and blue color filters 220, and an overcoat layer 230 are formed under an insulating substrate 201 of the color filter substrate 200. The BM is configured to prevent light leakage and light interference between adjacent pixel regions. The red, green, and blue color filters 220 are formed in pixel regions, respectively. The overcoat layer 230, which is formed of an organic material, is formed on the color filters 220. A common electrode 240, which is formed of a transparent conductive material such as ITO or IZO, is formed on the overcoat layer 230. The insulating substrate 201 may be formed of a transparent insulating material such as glass.

In detail, a heat transfer part 290 is formed on one side of the light blocking member 210, which has the other side contacting the insulating substrate 201. That is, the heat transfer part 290 can be formed between the light blocking member 210 and the overcoat layer 230. Also, the heat transfer part 290 may be formed as a layer corresponding to the light blocking member 210. That is, the heat transfer part 290 may be formed in the same pattern as that of the light blocking member 210, or in a pattern that may be included in the pattern shape of the light blocking member 210 so that the pattern is concealed by the pattern of the light blocking member 210. For example, the heat transfer part 290 may have a pattern having only a longitudinal or transverse direction, or a pattern having a narrower width than that of the light blocking member 210.

The heat transfer part 290 is formed near an LC layer 30 to prevent heat transferred from the outside from being transferred to the LC layer 30. That is, in the case where heat flows toward the LC layer 30 from the outside, the heat is not transferred to the LC layer 30 but to the outside of the substrate 201 through the heat transfer part 290. Since the heat directed to the LC layer 30 is transferred to the outside through the heat transfer part 290, the amount of heat flowing into the LC layer 30 may be reduced, so that phase transition in the LC layer caused by heat may be prevented. At this point, heat transfer through the heat transfer part 290 may be performed by conduction rather than radiation or convection. The heat transfer part 290 may prevent heat produced by sunlight flowing toward the color filter substrate 200 from being transferred to the LC layer 30 in the case where the display device is used in an outside environment as in a DID.

The heat transfer part 290 may be manufactured to include at least one of silicon carbide (SiC), aluminum nitride (AlN), or titanium carbide (TiC), or a combination selected from SiC, AlN, or TiC, having high thermal conductivity and a small thermal expansion coefficient. Silicon carbide (SiC) has excellent thermal stability at temperatures of 1500° C. or below, and excellent stability even under oxidation atmosphere. Also, silicon carbide (SiC) has relatively high thermal conductivity of about 4.6 W/cm° C., a small thermal expansion coefficient of 3 through 6, excellent electrical characteristics, excellent abrasion resistance, and excellent chemical stability. In an embodiment where the heat transfer part 290 is formed of silicon carbide (SiC), which is a material having an excellent thermal diffusion characteristic, the heat transfer part 290 transfers heat flowing from the outside to the outside of the LC layer 30, so that phase transition of the LC layer 30 may be prevented. The heat transfer part 290 including the silicon carbide (SiC) may be formed on the substrate 201 using a general method. The heat transfer part 290 does not interfere optically or electrically with the LCD including the substrate 201.

The heat transfer part 290 including the silicon carbide (SiC) may be formed in the same pattern as that of the light blocking member 210 on the color filter substrate 200, and is connected to a heat transfer line 280 extending to the outside, i.e., the outside of the color filter substrate 200. Also, the heat transfer line 280 may have an outer cover formed of a resin. The heat transfer line 280 connected to the heat transfer part 290 may extend to the outside through the flexible printed circuit film 72.

Referring to FIG. 3, the TFT substrate 100 and the color filter substrate 200 maintain a predetermined gap between them through a sealing member 21, and are connected to each other through a thermal conductive connection member 289. At this point, the thermal conductive connection member 289 has one side connected to the heat transfer part 290 formed on the color filter substrate 200, and the other side connected to the heat transfer line 280. Heat flowing to the heat transfer part 290 is transferred to the heat transfer line 280 through the thermal conductive connection member 289. Other connection methods besides a connection through the thermal conductive connection member 289 may be used.

The LC layer 30 is interposed between the TFT substrate 100 and the color filter substrate 200. Alignment layers for alignment of LCs are disposed on the surfaces of the TFT substrate 100 and the color filter substrate 200, respectively. The surfaces face each other. The alignment layers align LC molecules of the LC layer 30. At this point, the alignment mode of the LC molecules of the LC layer 30 may be a vertical alignment mode allowing the LC molecules to be vertically aligned with respect to each of the substrates, or alternatively, the alignment mode may not be the vertical alignment mode.

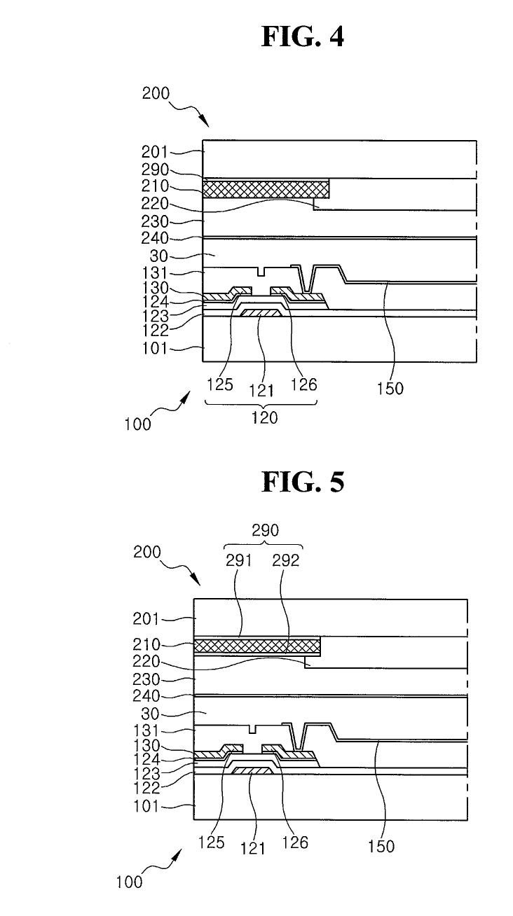

FIGS. 4 and 5 are views illustrating a modification of an embodiment.

The heat transfer part 290, which may include the silicon carbide (SiC), may be formed on one side of the light blocking member 210, which has the other side contacting the substrate 201 as illustrated in the embodiment of FIG. 2. In addition, the heat transfer part 290 may be formed between the substrate 201 and the light blocking member 210 as illustrated in the embodiment of FIG. 4. Furthermore, the heat transfer part 290 may have a construction in which a first heat transfer layer 291 is formed between the substrate 201 and one side of the light blocking member 210, and a second heat transfer layer 292 is formed on the other side of the light blocking member 210 as illustrated in the embodiment of FIG. 5. In these embodiments, the heat transfer part 290 may be formed on the light blocking member 210, and may have the same pattern as that of the light blocking member 210, or a pattern included in the pattern of the light blocking member 210.

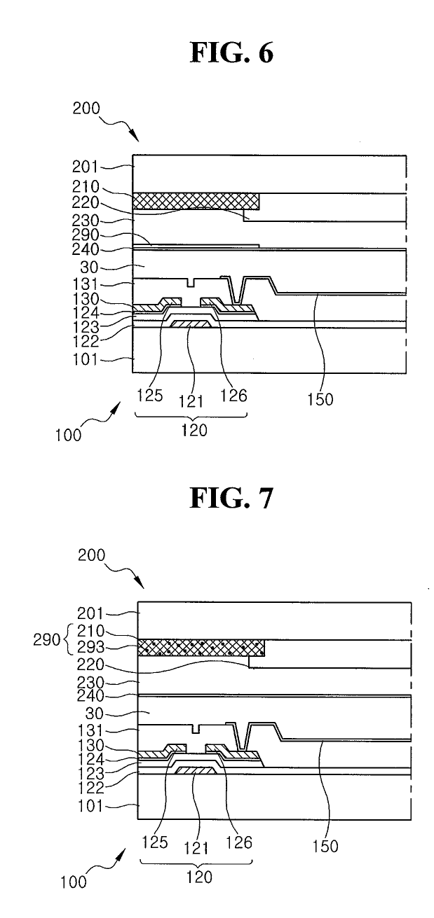

FIG. 6 is a view of an LCD according to another embodiment of the present disclosure.

Referring to FIG. 6, the heat transfer part 290 may be formed between the common electrode 240 and the overcoat layer 230. According to embodiments other than where the heat transfer part 290 is formed between the common electrode 240 and the overcoat layer 230, the heat transfer part 290 may also be formed between the light blocking member 210 and the color filter 220, between the light blocking member 210, the color filter 220, and the overcoat layer 230, between the color filter 220 and the overcoat layer 230, or between the common electrode 240 and the alignment layer (not shown). Also, the heat transfer part 290 may be formed on a surface of the substrate that does not face the LC layer 30.

In the same general manner, the heat transfer part 290 may be formed between a substrate 101 and a TFT 120, between the TFT 120 and a passivation layer 130, between the passivation layer 130 and a pixel electrode 150, or between the pixel electrode 150 and an alignment layer (not shown) on a TFT substrate 100. At this point, the heat transfer part 290 may be formed between a gate electrode 121, a gate insulating layer 122, an active layer 123, an ohmic contact layer 124, a source electrode 125, and a drain electrode 126, or formed on one side of the substrate 101 that does not face the LC layer 30. However, in these embodiments, the heat transfer part 290 may have the same pattern as that of the light blocking member 210. The heat transfer part 290 may have a pattern included in the pattern of the light blocking member 210. According to one or more embodiments where the heat transfer part 290 is formed on a TFT substrate 100, it prevents heat discharged from a backlight assembly, which will be described later, from flowing to the LC layer 30, and discharges the heat to the outside to secure excellent characteristics, particularly, a long time driving characteristic of the LCD.

Also, the heat transfer part 290 according to another embodiment may be connected to the outside through a heat transfer line 280 as the heat transfer part 290 according to the previous embodiment (as shown in FIG. 3).

FIG. 7 is a view of an LCD according to still another embodiment of the present disclosure.

Referring to FIG. 7, a heat transfer part 290 may be manufactured such that a heat transfer portion 293, which may include silicon carbide (SiC), is included in a light blocking member 210. At this point, the heat transfer portion 293, which may include silicon carbide (SiC), may be mixed with the material of the light blocking member 210 and thus included in the light blocking member 210. Also, the heat transfer portion 293 may be injected into the light blocking member 210 formed in advance through a method such as doping.

The heat transfer portion 293, which may include silicon carbide (SiC), may be included in a color filter substrate 200, or in other members of a TFT substrate 100 besides the light blocking member 210. That is, the heat transfer portion 293 may be included in a color filter 220, an overcoat layer 230, a common electrode 240, or an alignment layer (not shown) as well as in the light blocking member 210 on a substrate 201. Also, the heat transfer portion 293 may be included in a gate electrode 121, a gate insulating layer 122, an active layer 123, an ohmic contact layer 124, a source electrode 125, a drain electrode 126, a passivation layer 130, a pixel electrode 150, or an alignment layer (not shown) of the TFT substrate 100. According to one or more embodiments, the heat transfer portion 293 may also be included in the substrates 101 and 201. Therefore, the heat transfer part 290 according to still another embodiment may not be formed as the same layer as in the previous embodiments, but may be formed in a construction in which the heat transfer portion 293 is included in the various members.

In all cases, the heat transfer portion 293 may be included in a range that does not hinder the unique functions of the above-described various members. The various members including the heat transfer portion 293 may serve as the heat transfer part in addition to the unique function of the members. That is, the various members may have a heat transfer function of transferring heat to the outside so that the heat flowing from the outside to an LC layer 30 is not actually transferred to the LC layer 30 because of the inclusion of the heat transfer portion 293.

1 ppm or more of the heat transfer portion 293 may be included in the various members. In the case where a heat transfer portion 293 of less than 1 ppm is included, the various members may not perform the heat transfer function. However, the heat transfer portion 293 may be included in the range that does not hinder the unique functions of the various members as described above.

Also, the heat transfer portion 293 according to still another embodiment may be connected to the outside through a heat transfer line 280 as the heat transfer part 290 according to the previous embodiment (as shown in FIG. 3).

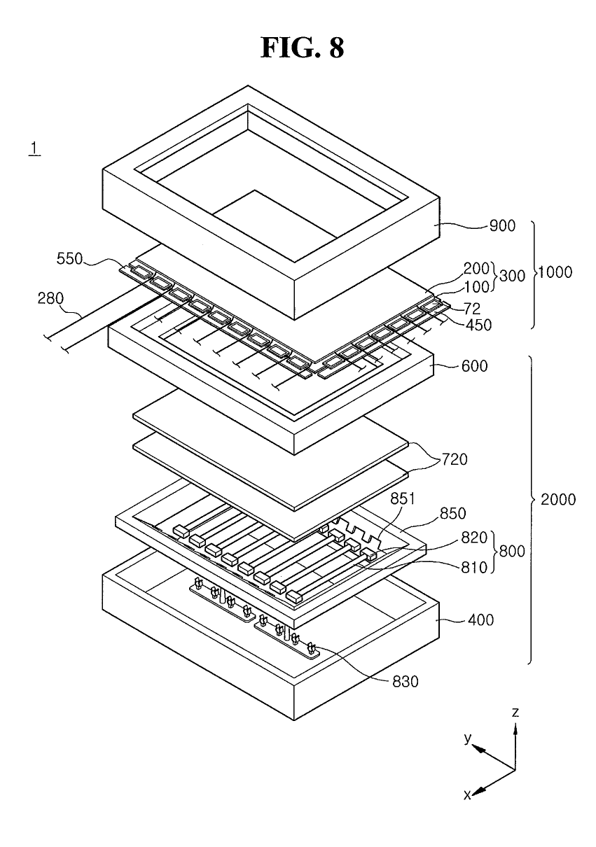

FIG. 8 is a schematic of an exploded perspective view of an LCD according to an embodiment of the present disclosure.

Referring to FIG. 8, the LCD 1 includes a display assembly 1000 disposed at an upper portion, and a backlight assembly 2000 disposed at a lower portion. The display assembly 1000 includes an LC panel 300 and an upper chassis 900.

The LC panel 300 includes a color filter substrate 200 and a TFT substrate 100. A driving circuit part includes a printed circuit board (PCB) 450 on a gate side connected to a gate line of the TFT substrate 100 through a flexible printed circuit film 72 on the gate side, and a PCB 550 on a data side connected to a data line of the TFT substrate 100 through the flexible printed circuit film 72 on the data side. The PCB 450 on the gate side may be omitted when necessary.

Also, the LC panel 300 includes a heat transfer part formed on the color filter substrate 200 or the TFT substrate 100. The heat transfer part may be connected to a heat transfer line 280. The heat transfer line 280 may extend to the outside of the LCD 1 even after the LCD 1 is assembled.

The upper chassis 900 may be manufactured in, for example, a quadrangular frame having a plane portion and a side portion perpendicularly bent to prevent elements of the display assembly 1000 from being detached, and simultaneously to protect the fragile LC panel 300 and backlight assembly 2000. At this point, the plane portion of the upper chassis 900 supports a portion of the edge of the LC panel 300 in its lower portion, and the side portion of the upper chassis 900 faces and is coupled to sidewalls of a lower chassis 400. The upper chassis 900 and the lower chassis 400 may be manufactured using lightweight metal having excellent strength and a small deformation characteristic.

Next, the backlight assembly 2000 includes a light source unit 800 generating light, a fixing unit 850 supportedly fixing the light source unit 800, optical members 720 disposed on the fixing unit 850, a mold frame 600 supporting the optical members 720, and the lower chassis 400 receiving the light source unit 800, the fixing unit 850, and the optical members 720.

The light source unit 800 includes a plurality of lamps 810 arranged at equal intervals, and lamp holders 820 provided at both ends of each lamp 810, respectively. In the present embodiment, the lamps 810 are arranged such that the lengthwise direction (i.e., an x-axis direction) of the lamps 810 is perpendicular to the long axis direction (i.e., a y-axis direction) of the lower chassis 400. It will be appreciated that the arrangement of the lamps 810 is not limited thereto, but the lamps 810 may also be arranged, for example, such that the lengthwise direction of the lamp 810 is parallel to the long axis direction (i.e., the y-axis direction) of the lower chassis 400.

The fixing unit 850 may be manufactured in a frame shape having an open lower side. A plurality of concave portions 851 supportedly fixing the lamp holders 820 of the light source unit 800 may be formed in one side of the fixing unit 850. With these concave portions 851, the fixing unit 850 supportedly fixes the plurality of lamps 810 of the light source unit 800 to prevent the lamps 810 from shaking and protect the lamps 810 from an external impact. It will be appreciated that the fixing unit 850 is not limited to the above-described structure, but may be modified to various shapes that may support and fix the plurality of lamps 810 of the light source unit 800.

The optical members 720 disposed on the fixing unit 850 may include a diffuser configured to diffuse light incident from the light source unit 800 such that the light has a uniform distribution over a wide range, and to direct the light to the front side of an LC display panel 300.

Also, the optical members 720 may include at least one prism sheet, at least one polarizing sheet, at least one brightness enhancing sheet, and at least one diffusion sheet. The polarizing sheet changes light such that light incident thereto at an inclined angle is perpendicularly emitted. The brightness enhancing sheet transmits light parallel to the transmission axis of the brightness enhancing sheet, and reflects light perpendicular to the transmission axis of the brightness enhancing sheet. The diffusing sheet allows incident light to be diffused and emitted in the form of plane light. The optical members 720 allow light to be incident perpendicularly to the LC panel 300 to improve light efficiency. The optical members 720 may selectively include at least one prism sheet, at least one polarizing sheet, at least one brightness enhancing sheet, at least one diffusion sheet, and at least one diffuser. For example, the optical members 720 may include one or more of a prism sheet, a polarizing sheet, a brightness enhancing sheet, a diffusion sheet and/or a diffuser.

The mold frame 600 may be manufactured in a quadrangular frame shape and may support the optical member 720, as well as the LC display panel 300 at the upper portion.

The lower chassis 400 may be formed in a rectangular parallelepiped box having an open upper side to include a receiving space of a predetermined depth inside. Also, a reflector (not shown) may be provided on the bottom side of the upper chassis 400.

It will be appreciated that the backlight assembly 2000 of the LCD 1 may have other structures different from the structure illustrated in the embodiment of FIG. 8.

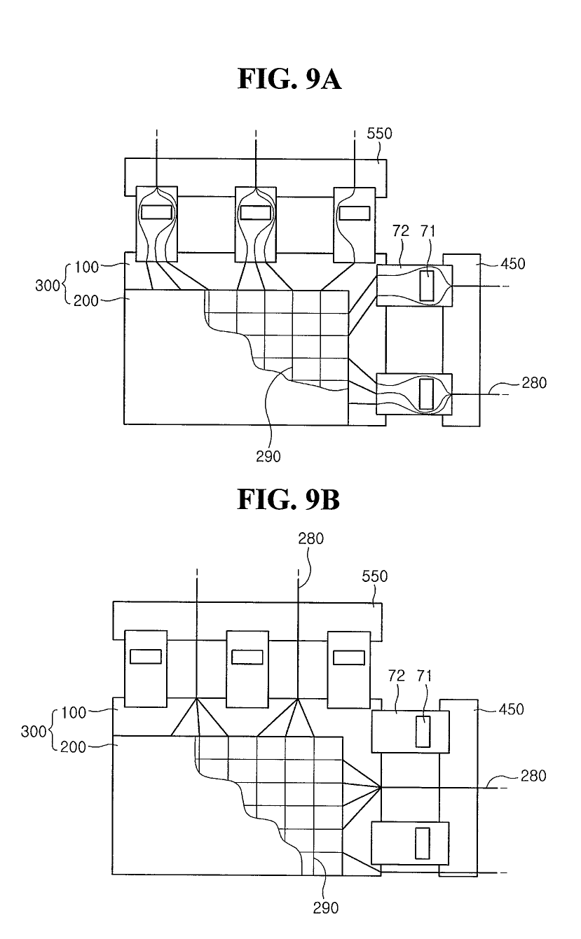

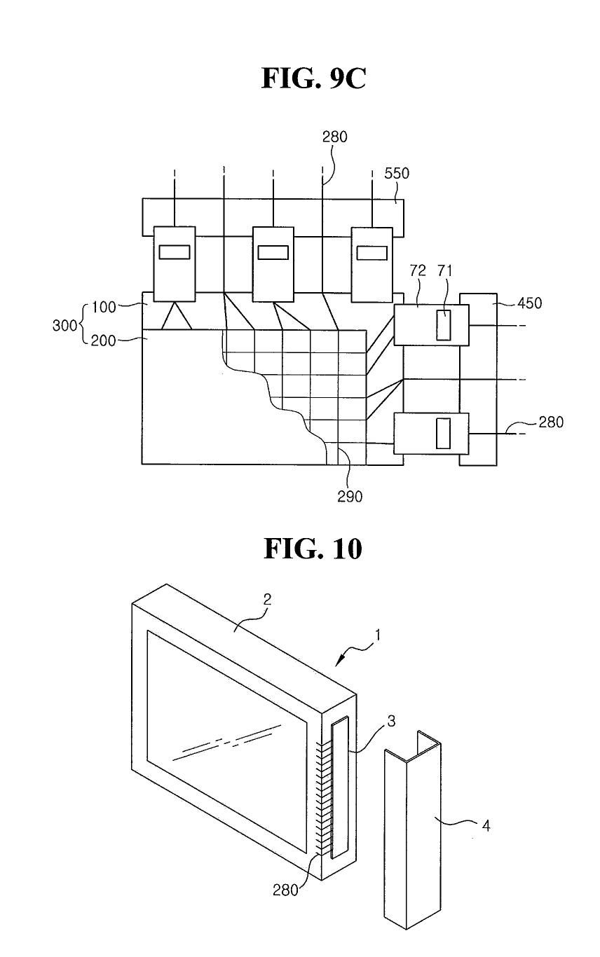

FIGS. 9A through 9C are plan views illustrating a portion of an LCD according to an embodiment of the present disclosure.

Referring to FIG. 9A, the heat transfer part 290, which may include silicon carbide (SiC), may be formed in the same pattern (e.g., a matrix arrangement) as that of the light blocking member 210 on the substrate 201, and may be connected to the heat transfer line 280 at the end of the color filter substrate 200. The heat transfer line 280 may be formed of the same material as that of the heat transfer part 290, or it may be formed of a material such as copper. Also, the heat transfer line 280 may have an outer cover formed of a resin. The heat transfer line 280 connected to the heat transfer part 290 extends to the outside through the flexible printed circuit film 72. Heat flowing to the heat transfer part 290 is transferred to the outside through the heat transfer line 280.

Referring to FIG. 9B, the heat transfer line 280 may extend to the outside through a region where the flexible printed circuit film 72 is not formed. Referring to FIG. 9C, the heat transfer line 280 may extend to the outside through the flexible printed circuit film 72 and through a region where the flexible printed circuit film 72 is not formed.

Also, respective heat transfer lines 280 may merge at the LC display panel 300 to form one or two heat transfer lines 280 and extend to the outside, or the heat transfer parts 290 may merge at the LC display panel 300 to connect to one or two heat transfer lines 280.

FIG. 10 is a perspective view of an LCD according to an embodiment of the present disclosure.

The rest of the LCD 1 excluding a display screen portion is received in a housing 2. The heat transfer line 280, more particularly, one end of the heat transfer line 280, having the other end connected to the heat transfer part of the color filter substrate 200 or the TFT substrate 100, may be connected to a cooling portion 3 and exposed to an outside environment such as the atmosphere.

The cooling portion 3 discharges heat transferred from the heat transfer part through the heat transfer line 280 to the outside environment such as the atmosphere. The cooling portion 3 may have an extended surface area to improve heatsink performance. Also, although the heatsink performance of the cooling portion 3 may be achieved through air cooling where the LCD is disposed in an outside environment such as the atmosphere, the cooling portion 3 may include a forced air cooling unit or a water cooling unit that assists the heatsink performance. Also, a protecting cover 4 may be provided to protect a user or other devices adjacent to the LCD 1 from the heatsink from the cooling portion 3 facing the outside, or to arbitrarily control the heatsink direction of the cooling portion 3.

Heat inflow to the LC layer 30 may be prevented through the above-described heatsink operation, and instead, the heat inflow may be discharged to the outside to prevent phase transition of the LC layer 30 and thus improve the driving characteristic of the LCD 1.

The display substrate and the display device of the exemplary embodiments prevent heat from being generated inside a display device, and from flowing into the inside of the device, thus preventing temperature from rising. The generated heat may be easily discharged to the outside.

The display substrate and the display device of the exemplary embodiments prevent heat from flowing into LCs of a display device, and discharges heat to the outside to prevent phase transition of the LCs.

Also, the display substrate and the display device of the exemplary embodiments allow heat to be easily discharged to improve the driving characteristic of a display device. The display substrate and the display device of the exemplary embodiments may apply to a large-sized display device such as a digital information display (DID).

Although the display substrate and the display device have been described with reference to the specific embodiments, they are not limited thereto. Therefore, it will be readily understood by those skilled in the art that various modifications and changes can be made thereto without departing from the spirit and scope of the present invention defined by the appended claims.

Particularly, although an LCD has been described throughout the specification, the display substrate and the display device according to embodiments of the present disclosure are not limited thereto but can be readily applied to other types of display devices, for example, organic light emitting diodes and plasma display devices.

What is claimed is:

1. A display substrate comprising:
a substrate;
a light blocking member disposed on the substrate; and
a heat transfer part contacting the light blocking member.

2. The display substrate of claim 1, wherein the heat transfer part is formed on an upper surface of the light blocking member.

3. The display substrate of claim 1, wherein the heat transfer part is formed on a lower surface of the light blocking member.

4. The display substrate of claim 1, wherein the heat transfer part comprises at least one of, or a combination selected from, silicon carbide (SiC), aluminum nitride (AlN), or titanium carbide (TiC).

5. The display substrate of claim 1, wherein the heat transfer part has a size equal to or smaller than that of the light blocking member.

6. A display device comprising:
a first substrate;
a light blocking member disposed on the first substrate;
a color filter disposed on the light blocking member,
a common electrode disposed on the color filter;
a second substrate facing the first substrate;
a thin film transistor disposed on the second substrate;
a passivation layer disposed on the thin film transistor;
a pixel electrode disposed on the passivation layer; and
a heat transfer part disposed on the first substrate or the second substrate.

7. The display device of claim 6, wherein the heat transfer part has a size corresponding to that of the light blocking member.

8. The display device of claim 7, wherein the heat transfer part is formed on at least one of at least one side of the first substrate, at least one side of the light blocking member, and at least one side of the common electrode.

9. The display device of claim 7, wherein the heat transfer part is formed on at least one of at least one side of the second substrate, at least one side of the thin film transistor, at least one side of the passivation layer, and at least one side of the pixel electrode.

10. The display device of claim 6, wherein the heat transfer part comprises at least one of, or a combination selected from, silicon carbide (SiC), aluminum nitride (AlN), or titanium carbide (TiC).

11. The display device of claim 6, wherein the heat transfer part has a size equal to or smaller than that of the light blocking member.

12. The display device of claim 6, further comprising:
a printed circuit film disposed on at least one of the first substrate and the second substrate; and
a heat transfer line having one end connected to the heat transfer part through the printed circuit film or escaping the printed circuit film, and having the other end connected to an exposure portion exposed to an outside environment.

13. The display device of claim 12, wherein the exposure portion is surrounded by a protector.

14. A display device comprising:
a first substrate comprising at least one of a light blocking member, a color filter, an overcoat layer, an alignment layer, and a common electrode; and
a second substrate attached to the first substrate, and comprising at least one of a thin film transistor, a passivation layer, and a pixel electrode,
wherein a heat transfer part comprising a heat transfer portion is disposed on the first substrate or the second substrate.

15. The display device of claim 14, wherein the heat transfer portion comprises at least one of, or a combination selected from, silicon carbide (SiC), aluminum nitride (AlN), or titanium carbide (TiC).

16. The display device of claim 14, wherein the heat transfer part comprises 1 ppm or more of the heat transfer portion.

17. The display device of claim 14, further comprising:
a printed circuit film disposed on at least one of the first substrate and the second substrate; and
a heat transfer line having one end connected to the heat transfer part through the printed circuit film or escaping the printed circuit film, and having the other end connected to an exposure portion exposed to an outside environment.

18. The display device of claim 17, wherein the exposure portion is surrounded by a protector.

19. The display device of claim 14, further comprising a liquid crystal layer.
